(19) United States
(12) Patent Application Publication
(10) Pub. No.: US 2017/0139369 A1
(43) Pub. Date: May 18, 2017

(54) IMAGE FORMING APPARATUS

(71) Applicant: KYOCERA Document Solutions Inc., Osaka (JP)

(72) Inventor: Akinori MATSUNO, Osaka-shi (JP)

(73) Assignee: KYOCERA Document Solutions Inc., Osaka (JP)

(21) Appl. No.: 15/295,064

(22) Filed: Oct. 17, 2016

(30) Foreign Application Priority Data
Nov. 17, 2015 (JP) 2015-224488

(51) Int. Cl. G03G 15/00; H04N 1/00; H04N 1/31

(52) U.S. Cl. CPC G03G 15/80; H04N 1/31; H04N 1/00559; H04N 1/00519; H04N 1/00551; H04N 2201/0094

(57) ABSTRACT

An image forming apparatus includes a main board, a power supply board, a base member, a first shielding member and a second shielding member. The main board controls an image forming operation. The power supply board is disposed adjacent to the main board to supply power to the main board. On the base member, the main board and the power supply board are supported. The first shielding member is fixed on the base member so as to cover the main board and the power supply board. The second shielding member is fixed on the base member between the main board and the power supply board.

### INCORPORATION BY REFERENCE

This application is based on and claims the benefit of priority from Japanese Patent application No. 2015-224488 filed on Nov. 17, 2015, the entire contents of which are incorporated herein by reference.

### BACKGROUND

The present disclosure relates to an image forming apparatus including an electrical board.

An image forming apparatus, such as a printer or a multifunction peripheral, is provided with a main board controlling an image forming operation and a power supply board supplying power to the main board. Alternating current (AC) power supplied from an external power source is converted from a primary circuit to a secondary circuit on the power supply board, and then, the converted power is supplied to the main board.

The main board is electrically shielded by a shielding member in order to prevent a leakage to the outside of a radio noise caused by a digital signal with a high frequency and the power supply board is also electrically shielded by a shielding member in order to prevent a leakage to the outside of an AC line noise from the primary circuit. For example, there is known an image forming apparatus in which a shielding member of a main board and a shielding member of a power supply board are provided separately from each other and are overlapped to each other and fastened by a screw.

In a case where the shielding member of the main board and the shielding member of the power supply board are overlapped to each other and fastened by the screw, because procedures for attaching and detaching the shielding members are determined in advance, there is a problem that workability of attaching or detaching the shielding members is lowered.

Further, if the main board is disposed in the vicinity of the primary circuit of the power supply board, because the main board is adversely affected by the AC line noise, it is necessary to dispose the power supply board and the main board at a predetermined interval or to design a circuit of the power supply board without disposing the primary circuit in the vicinity of the main board. Thus, there is a problem that the main board and the power supply board have restriction in layout, and then, it is impossible to cope with downsizing of image forming apparatuses or the workability of circuit design is lowered.

### SUMMARY

In accordance with the present disclosure, an image forming apparatus includes a main board, a power supply board, a base member, a first shielding member and a second shielding member. The main board controls an image forming operation. The power supply board is disposed adjacent to the main board to supply power to the main board. On the base member, the main board and the power supply board are supported. The first shielding member is fixed on the base member so as to cover the main board and the power supply board. The second shielding member is fixed on the base member between the main board and the power supply board.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a perspective view of a color printer according to an embodiment of the present disclosure.

FIG. 2 is a view showing a left side view of a casing in the color printer according to the embodiment of the present disclosure.

FIG. 3 is a perspective view showing a base member in the color printer according to the embodiment of the present disclosure.

FIG. 4A is a perspective view showing a first shielding member and FIG. 4B is a perspective view of a second shielding member in the color printer according to the embodiment of the present disclosure.

FIG. 5 is a perspective view showing the base member, to which the second shielding member is attached, in the color printer according to the embodiment of the present disclosure.

FIG. 6 is a perspective view showing the base member, to which a main board and a power supply board is attached, in the color printer according to the embodiment of the present disclosure.

FIG. 7 is a perspective view showing the base member, to which the first shielding member is attached, in the color printer according to the embodiment of the present disclosure.

FIG. 8 is a perspective view showing the base member, to which a rear left cover is attached, in the color printer according to the embodiment of the present disclosure.

FIG. 9 is a sectional view showing a mounting piece of the second shielding member and the power supply board to clarify a positional relationship to each other in the color printer according to the embodiment of the present disclosure.

### DETAILED DESCRIPTION

Hereinafter, an image forming apparatus according to an embodiment of the present disclosure will be described with reference to the accompanying drawings.

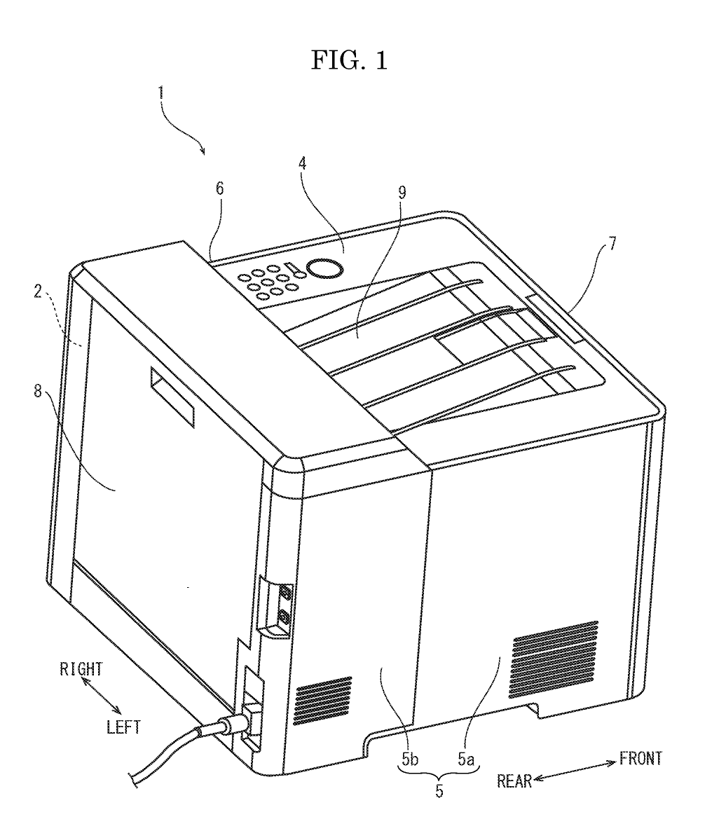

Firstly, with reference to FIG. 1, a color printer as the image forming apparatus according to the embodiment of the present disclosure will be described. FIG. 1 is a perspective view showing the color printer. Forward and backward directions and left and right directions in the following description are respectively based on forward and backward directions and left and right directions shown on a paper sheet of FIG. 1.

An image forming apparatus 1 includes a parallelepiped casing 2 housing an image forming part and an exterior cover covering the outside of the casing 2. The exterior cover has a top face cover 4 covering a top face of the casing 2, a left side face cover 5 and a right side face cover 6 respectively covering left and right side faces thereof, and a front cover 7 and a rear cover 8 respectively covering front and rear faces thereof. On the top face cover 4, an ejected sheet tray 9 is formed. The left cover 5 is divided into a front left cover 5a and a rear left cover 5b. The rear left cover 5b is made of resin material with the standard of a flame retardant property lower than 5VB in the UL94 standard indicating combustibility. For example, this cover is made of resin material of the flame retardant property of HB.

Inside the casing 2, a sheet feeding cartridge storing a sheet and the image forming part forming an image on a sheet are housed. Also, inside the casing 2, a sheet feeding and conveying part feeding the sheet from the sheet feeding cartridge and conveying the sheet to the ejected sheet tray 9 through the image forming part is arranged.

The image forming part is composed of four image forming units forming toner images in an electrographic manner. Each image forming unit is provided for each toner color and is composed of constituent elements, such as a photosensitive drum, a charging device, a development device and a cleaning device. Each constituent element is driven by a drive transmission mechanism. The drive transmission mechanism is composed of a motor, a gear train and others, and the gear train transmits a driving force of the motor to each constituent element of each image forming unit.

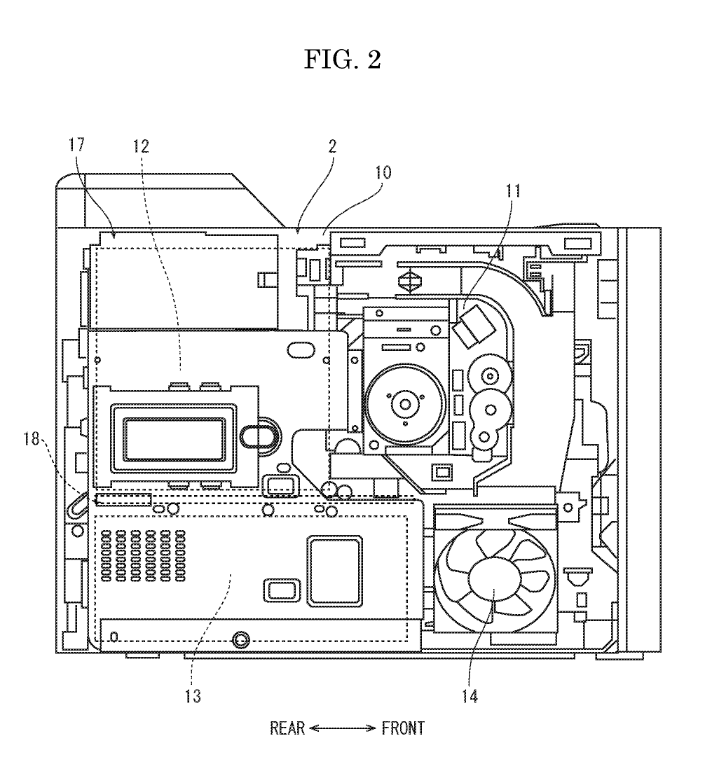

Next, with reference to FIG. 2, the casing 2 will be described. FIG. 2 is a figure of the casing as seen from a left side.

On a left side face of the casing 2, a base member 10 is provided. On an outside face of the base member 10, a drive transmission mechanism supporting plate 11 supporting the drive transmission mechanism, a main board 12 controlling driving of the image forming part and the sheet feeding and conveying part, a power supply board 13 connected to an external power source and disposed adjacent to the main board 12 to supply power to the main board 12, a fan 14 and others are supported. Further, to the base member, a first shielding member 17 and a second shielding member 18 electrically shielding the main board 12 and the power supply board 13 are fixed.

The drive transmission mechanism supporting plate 11 is supported on a front upper part on the outside face of the base member 10 and the fan 14 is supported below the drive transmission supporting plate 11. In addition, the main board 12 is supported on a rear upper part on the outside face of the base member 10 and the power supply board 13 is supported below the main board 12. The main board 12 has a roughly square shape and, on top and back faces thereof, a CPU, a memory, a variety of electrical components, connectors and other components are mounted. The power supply board 13 has a transversely elongated rectangular shape and, on top and bottom faces thereof, capacitors, transformers and other components are mounted.

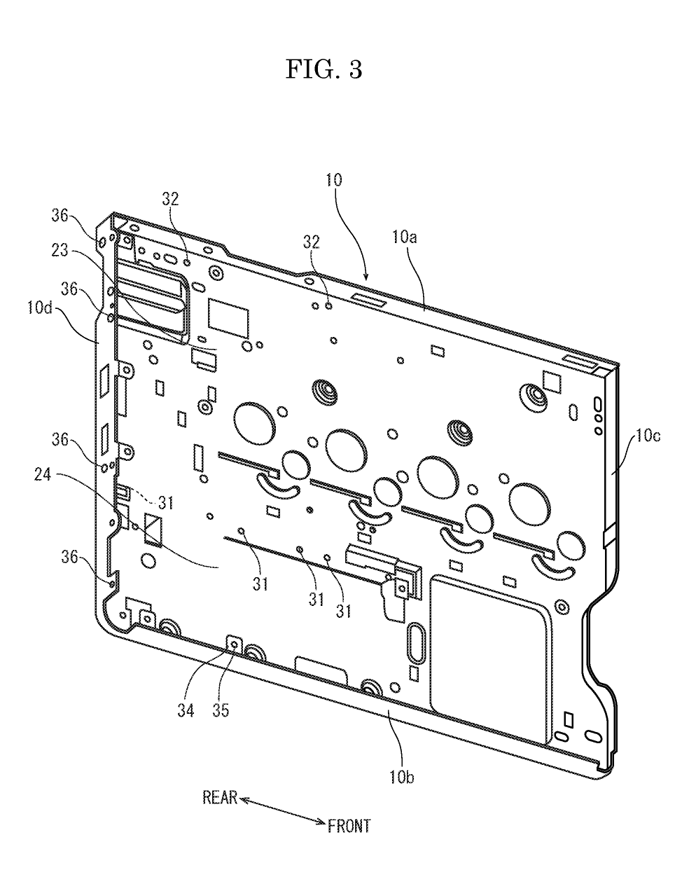

Next, with reference to FIG. 3, the base member of the casing 2 will be described. FIG. 3 is a perspective view showing the base member.

The base member 10 has a rectangular shape and is made of metal plate material. On the base member 10, an upper side edge 10a, a lower side edge 10b, a front side edge 10c and a rear side edge 10d bent to the outside (the left side) along upper and lower edges and front and rear edges are respectively formed. In a depression surrounded by the upper side edge 10a, the lower side edge 10b, the front side edge 10c and the rear side edge 10d, the drive transmission mechanism supporting plate 11, the main board 12, the power supply board 13, the fan 14 and other components are adapted to be housed.

In the rear upper part of the base member 10, a main board mounting part 23 to which the main board 12 is to be mounted is formed and, in a rear lower part thereof, a power supply board mounting part 24 to which the power supply board 13 is to be mounted is formed. Further, between the main board mounting part 23 and the power supply board mounting part 24, four screw holes 31 are formed to be arranged in the forward and backward directions direction. Furthermore, above the main board mounting part 23, two screw holes 32 are formed at a predetermined interval in the forward and backward directions.

In the lower side edge 10b, a mounting piece 34 is bent upwardly is formed and, in the mounting piece 34, a screw hole 35 is formed. In the rear side edge 10d, three screw holes 36 are formed at predetermined intervals in upward and downward directions.

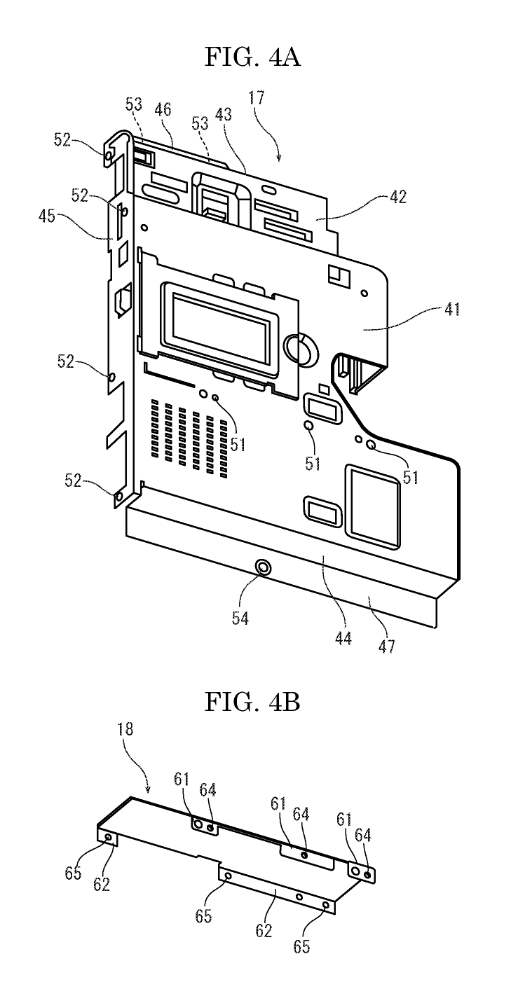

Next, with reference to FIG. 2 and FIG. 4A and FIG. 4B, the first shielding member 17 and the second shielding member 18 will be described. FIG. 4A is a perspective view showing the first shielding member and FIG. 4B is a perspective view showing the second shielding member.

As shown in FIG. 2, the first shielding member 17 is fixedly supported on the base member 10 so as to cover the main board 12 and the power supply board 13 and electrically shields the main board 12 and the power supply board 13. The second shielding member 18 is fixed on the base member 10 between the main board 12 and the power supply board 13 and electrically shields a boundary between the boards.

As shown in FIG. 4A, the first shielding member 17 has a first top board 41 (a parallel part) covering an outside face of a lower part of the main board 12 and an outside face of the power supply board 13, a second top plate 42 (a parallel part) formed in a stepwise shape smaller in height than the first top plate 31 and covering an upper part of the main board 12, an upper side plate 43 bent to the inside (the right side) from an upper edge of the second top plate 42, a lower side plate 44 bent to the inside from a lower edge of the first top plate 41, and a left side plate 45 bent to the inside from left edges of the first top plate 41 and the second top plate 42. On the upper side plate 43, an upper mounting piece 46 bent upwardly from an end edge thereof is formed and, on the lower side plate 44, a lower mounting piece 47 bent downwardly from the end edge thereof is formed. The first shielding member 17 is made of material, such as a metal plate material, having an electric conductivity.

On the first top plate 41, in the vicinity of a center in the upward and downward directions, three circular apertures 51 are formed to be arranged in the forward and downward directions. In the left side plate 45, four circular apertures 52 are formed at predetermined intervals in the upward and downward directions. In the upper mounting piece 46, two circular apertures 53 are formed at a predetermined interval in the forward and downward directions. In the lower mounting piece 47, a circular aperture 54 is formed at a central part in the forward and downward directions.

As shown in FIG. 4B, the second shielding member 18 is formed in a transversely elongated rectangular shape and has a width slightly larger than a width of the main board 12. In the second shield member 18, three mounting pieces 61 bent at a right angle from an edge of one long edge side thereof, and two mounting pieces 62 bent at a right angle from an edge of another long edge side thereof. In the mounting pieces 61 formed at the edge of one long edge side, the screw holes 64 are respectively formed. In the mounting pieces 62 formed at the edge of another long edge side, one circular aperture 65 and three circular apertures 65 are formed.

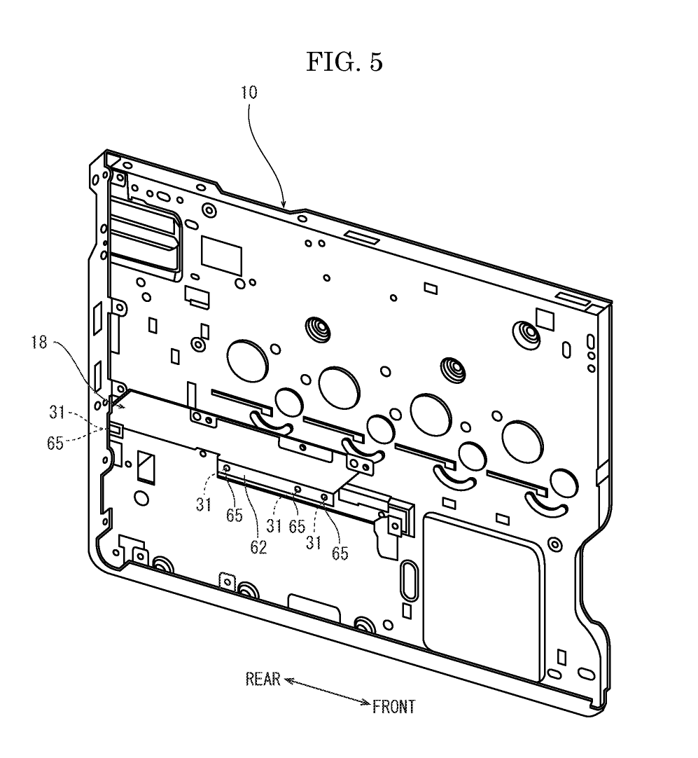

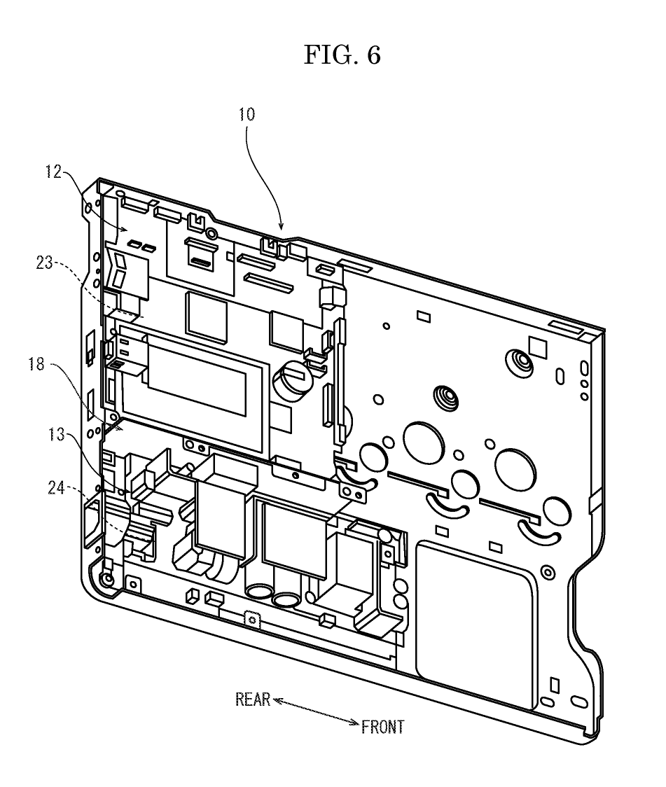

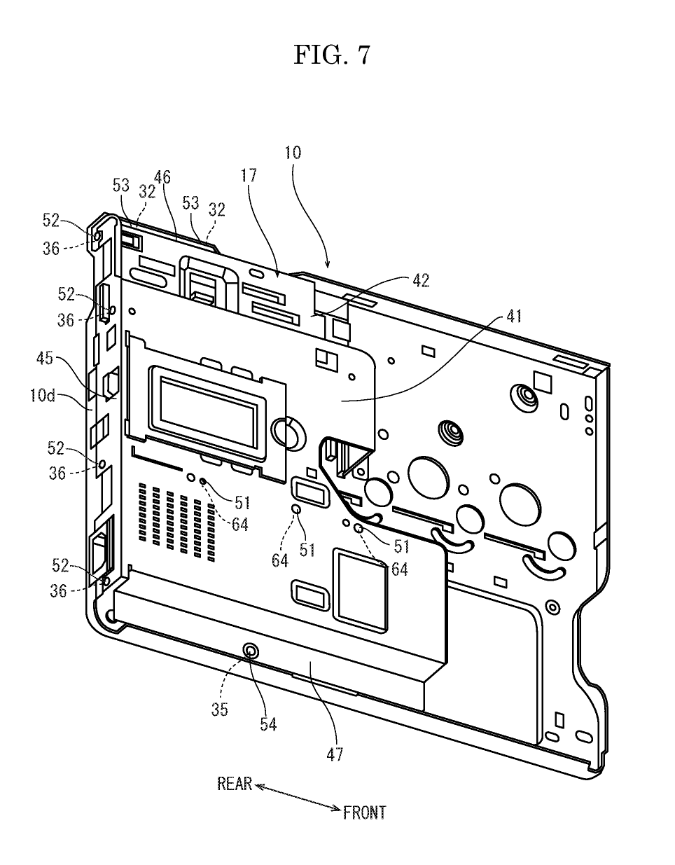

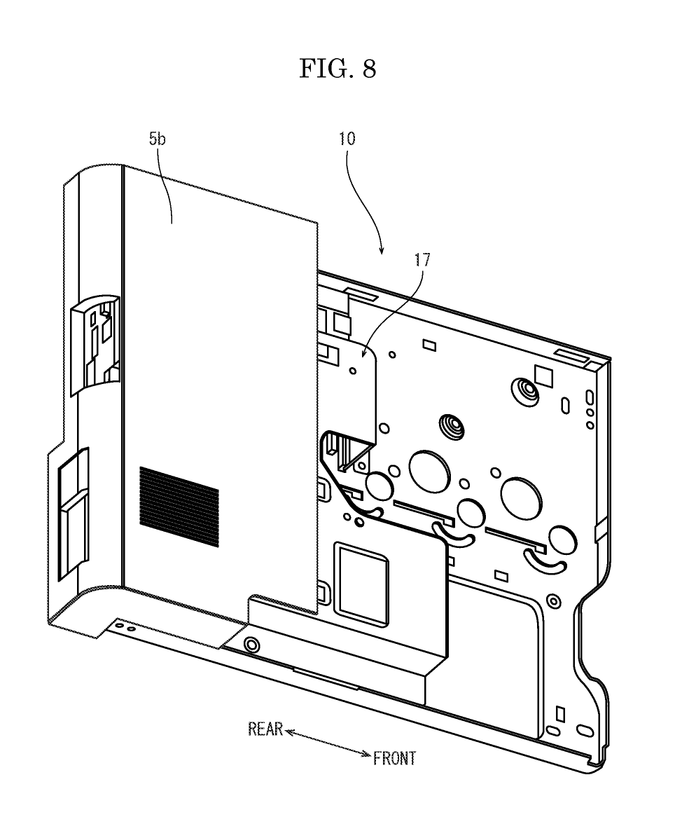

A procedure for electrically shielding the main board and the power supply board mounted on the base member 10 by the first shielding member 17 and the second shielding member 18 having the above-described construction will be described with reference to FIG. 5 to FIG. 8. FIG. 5 is a perspective view showing the member to which the second shielding member has been mounted. FIG. 6 is a perspective view of the base member to which the main board and the power supply board have been moreover mounted. FIG. 7 is a perspective view showing the base member to which the first shielding member has been further mounted. FIG. 8 is a perspective view showing the base member to which the rear left cover has been furthermore mounted.

Firstly, as shown in FIG. 5, the second shielding member 18 is fixed on the base member 10. At this time, each aperture 65 of each mounting piece 62 formed at the edge of another long edge side of the second shield member 18 are associated with the screw hole 31 formed between the main board mounting part 23 and the power supply board mounting part 24 of the base member 10, and then, a screw is inserted through each aperture 65 and fastened to each screw hole 31. In this manner, the second shielding member 18 is mounted so as to be perpendicularly erected with respect to the outside face of the base member 10 and is grounded to the base member 10.

Next, as shown in FIG. 6, the main board 12 and the power supply board 13 are respectively mounted to the main board mounting part 23 and the power supply board mounting part 24 of the base member 10 by screw. At this time, the mounting pieces 61 and 62 of the second shielding member 18 and the power supply board 13 overlaps each other in a direction perpendicular to the outside face of the base member 10.

Subsequently, as shown in FIG. 7, the first shielding member 17 is fixed on the base member 10. At this time, the first top plate 41 is positioned so as to cover the lower part of the main board 12 and the power supply board 13 and the second top plate 42 is positioned so as to cover the upper part of the main board 12. Moreover, the upper mounting piece 46 is brought into contact with an upper portion of the main board mounting part 23 of the base member 10 and each aperture 53 is associated with each screw hole 32. Further, the left side plate 45 is overlapped to the outside of the rear side edge 10d of the base member 10 and each aperture 52 is associated with to each screw hole 36. Furthermore, the lower mounting piece 47 is brought into contact the mounting piece 34 of the lower side edge 10b of the base member 10 and the aperture 54 is associated with the screw hole 35. In addition, a screw is inserted through each aperture and fastened to each screw hole. If the first shield member 17 is thus fixed on the base member 10, the first top plate 41 and the second top plate 42 are parallel to a bottom face of the base member 10.

Further, each aperture 51 formed at a central part in the upward and downward directions of the first shielding member 17 is associated with each screw hole 64 of the mounting piece 61 formed in the edge of one long edge side of the second shielding member 18 and a screw is inserted through each aperture 51 and is fastened to each screw hole 64.

Thus, the first shield member 17 and the second shielding member 18 are fastened to the base member 10 by the screws and fastened to each other by the screws.

Lastly, as shown in FIG. 8, the rear left cover 5b is attached to a rear part of the base member 10.

As has been described hereinabove, according to the color printer 1 of the present disclosure, the main board 12 and the power supply board 13 are electrically shielded by the first shielding member 17, and thereby, an electromagnetic wave and noise leakage can be prevented. Moreover, the main board 12 and the power supply board 13 can be electrically shielded by the second shielding member 18. Therefore, since the main board 12 and the power supply board 13 can be disposed close to each other, downsizing of the color printer 1 can be actualized. Further, since there is no restriction in layout between the primary circuit and the secondary circuit of the power supply board 13, design efficiency of the power supply board 13 can be enhanced. In addition, a circuit design of the power supply board can be facilitated.

Further, since, by removing the first shielding member 17 from the base member 10, the main board 12 and the power supply board 13 can be attached to and detached from the base member 10, it is possible to make maintenance or replacement work of the main board 12 and the power supply board 13 easy, that is, to improve the workability of replacement and maintenance.

Furthermore, since the first shielding member 17 and the second shielding member 18 are fastened to each other by screws and are fastened to the base member 10 by screws, it is possible to enhance shielding effect and mounting rigidity between the first shielding member 17 and the second shielding member 18. In addition, since the first shielding member 17 is supported on the base member 10 by the second shielding member 18 in the vicinity of the center in the upward and downward directions, it is possible to achieve rigidity with respect to an impact applied in the vicinity of the center in the upward and downward directions and to enhance rigidity of the first shielding member. In particular, since the second shielding member 18 is perpendicularly erected with respect to the base member 10, it is possible to achieve higher rigidity. Moreover, as described above, since the first shielding member and the second shielding member can be reliably connected to the base member, it is possible to enhance noise elimination effect.

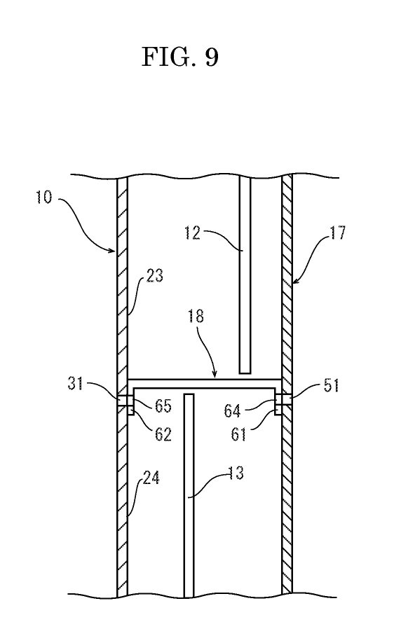

Still furthermore, as shown in FIG. 9, since the mounting pieces 61 and 62 of the second shielding member 18 and the power supply board 13 are overlapped to each other in the direction perpendicular to the base member 10, it is possible to decrease a mounting area of the shielding member 18 and to more reduce a gap between the main board 12 and the power supply board 13, that is, to dispose the boards more close to each other, and therefore, to effectively downsize the color printer 1.

Further, the first shielding member 17 is made of metal plate material and has high fire resistance. Therefore, since the rear left cover 5b covering the outside of the first shield member 17 can be made of resin with low flame retardant property and low costs and the exterior cover can be made of comparatively inexpensive material, it is possible to advantageously reduce cost of the color printer 1.

Further, the embodiment was described in a case of applying the configuration of the present disclosure to the color printer 1. On the other hand, in another embodiment, the configuration of the disclosure may be applied to another image forming apparatus, such as a copying machine, a facsimile or a multifunction peripheral, except for the printer 1.

Further, the above-description of the embodiments was described about one example of the image forming apparatus including this according to the present disclosure. However, the technical scope of the present disclosure is not limited to the embodiments. Components in the embodiment described above can be appropriately exchanged with existing components, and various variations including combinations with other existing components are possible. The description of the embodiment described above does not limit the content of the disclosure described in the claims.

What is claimed is:

1. An image forming apparatus comprising:
a main board controlling an image forming operation;
a power supply board disposed adjacent to the main board to supply power to the main board;
a base member on which the main board and the power supply board are supported;
a first shielding member fixed on the base member so as to cover the main board and the power supply board; and
a second shielding member fixed on the base member between the main board and the power supply board.

2. The image forming apparatus according to claim 1, wherein
the first shielding member and the second shielding member are fastened to the base member by screws.

3. The image forming apparatus according to claim 1, wherein
the first shielding member and the base member have respective parallel parts parallel to each other,
the second shielding member is disposed perpendicular each of the parallel parts and is fastened to each of the parallel parts by screws.

4. The image forming apparatus according to claim 1, wherein
the second shielding member has a mounting piece fastened to the base member by screws,
the mounting piece is partially overlapped to the main board or the power supply board in a direction perpendicular to the base member.

5. The image forming apparatus according to claim 1, further comprising:
an exterior cover covering an outside of the first shielding member,
the exterior cover has combustibility lower than 5VB in UL94 standard indicating combustibility.

6. The image forming apparatus according to claim 1, wherein
the main board and the power supply board is attached to and detached from the base member by removing the first shielding member from the base member.

7. The image forming apparatus according to claim 1, wherein
the base member supports, in addition to the main board and the power supply board, a drive transmission mechanism supporting plate supporting a drive transmission mechanism and supports a fan.

8. The image forming apparatus according to claim 1, wherein
the second shielding member is grounded to the base member.
